(19) United States
(12) Patent Application Publication
(10) Pub. No.: US 2016/0162578 A1
(43) Pub. Date: Jun. 9, 2016

(54) TRANSITIVE TRUST SOCIAL-NETWORK SYSTEM

(71) Applicant: Cisco Technology, Inc., San Jose, CA (US)

(72) Inventors: Suhas NANDAKUMAR, San Jose, CA (US); Keith GRIFFIN, Oranmore (IE)

(21) Appl. No.: 14/562,815

(22) Filed: Dec. 8, 2014

(51) Int. Cl. G06F 17/30; G06Q 50/00

(52) U.S. Cl. CPC G06F 17/30861; G06F 17/30342; G06Q 50/01

(57) ABSTRACT

In one embodiment, a system comprises a processor to maintain a skills database including different skill tags, each skill tag having an associated description, and a plurality of different subjects, each of the subjects being associated with a person, receive an endorsement for a first one of the subjects from a second one of the subjects endorsing a first one of the skill tags of the first subject, create a link linking the first subject with the first skill tag in the skills database, and based on receiving the endorsement, assign, in the skills database, a first expertise level to the first skill tag of the first subject, the first expertise level being dependent at least on one of the skill tags of the second subject and on a second expertise level assigned to the one skill tag of the second subject. Related apparatus and methods are also described.

### TECHNICAL FIELD

The present disclosure generally relates to social-network systems.

### BACKGROUND

Social software systems are often used for informal expertise searching. Expertise tagging may be based on endorsements received from various parties.

### BRIEF DESCRIPTION OF THE DRAWINGS

The present disclosure will be understood and appreciated more fully from the following detailed description, taken in conjunction with the drawings in which:

FIG. 1 is a block diagram view of a social-network skill system constructed and operative in accordance with an embodiment of the present invention;

FIG. 2 is a partly pictorial, partly block diagram view of social networks with endorsed skill tag expertise levels;

FIG. 3 is a block diagram view of the social-network skill system processing a skill search query;

FIG. 4 is a view of a skill search report produced by the system of FIG. 1 and ordered by social network distance and then expertise;

FIG. 5 is a view of a skill search report produced by the system of FIG. 1 and ordered by expertise and then social network distance; and

FIG. 6 is a view of a skill search report produced by the system of FIG. 1 listing the highest scoring result.

### DESCRIPTION OF EXAMPLE EMBODIMENTS

### Overview

There is provided in accordance with an embodiment of the present invention, a system including a processor, and a memory to store data used by the processor, wherein the processor is operative to maintain a skills database including a plurality of different skill tags, each of the skill tags having an associated description, and a plurality of different subjects, each of the subjects being associated with a person, receive an endorsement for a first one of the subjects from a second one of the subjects endorsing a first one of the skill tags of the first subject, create a link linking the first subject with the first skill tag in the skills database, and based on receiving the endorsement, assign, in the skills database, a first expertise level to the first skill tag of the first subject, the first expertise level being dependent at least on one of the skill tags of the second subject and a second expertise level assigned to the one skill tag of the second subject.

### Description Continued

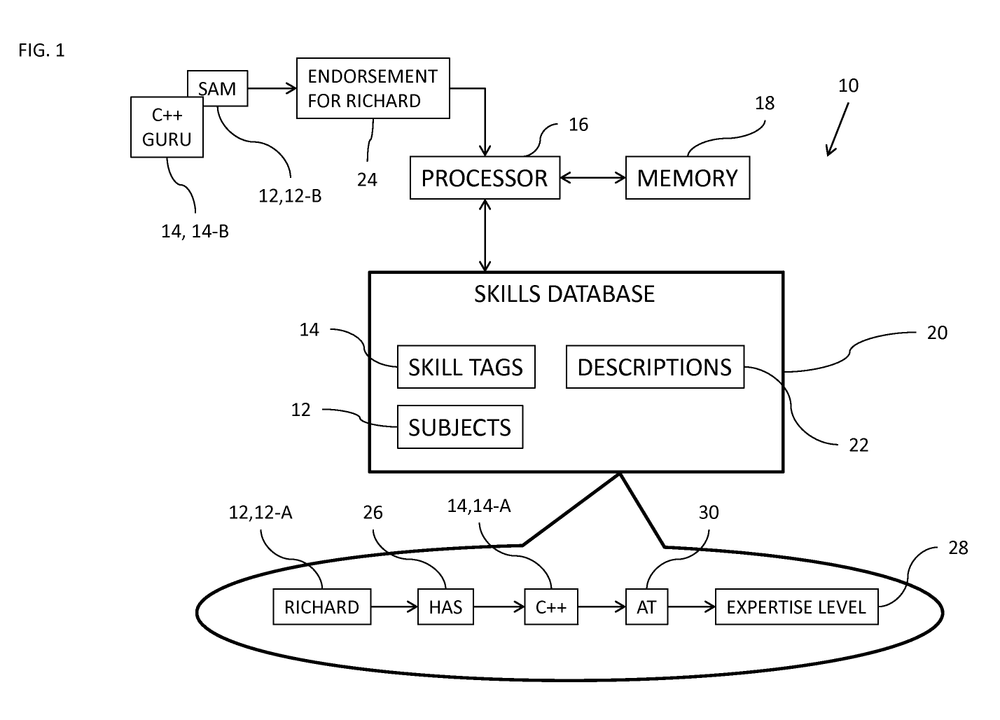

Reference is now made to FIG. 1, which is a block diagram view of a social-network skill system 10 constructed and operative in accordance with an embodiment of the present invention.

By way of introduction, the social-network skill system 10 allows subjects 12 (associated with people) to be tagged with one or more skill tags 14. Each skill tag 14 assigned to one of the subjects 12 may be assigned a level of expertise based on endorsements received from other subject(s) 12. Endorsements are considered valuable if the subject 12 providing the endorsement is suitably qualified to give an endorsement. In the social-network skill system 10, a suitable qualification for giving an endorsement is to have a certain level of expertise in the skill being endorsed or a certain level of expertise in a skill which includes the skill being endorsed. For example, an endorsement from an existing high strength Unified Communications expert of another subject 12 having a skills tag 14 in Unified Communications may carry a maximum skill weighting in determining the expertise level to associate with the skills tag 14 of that subject 12 being endorsed.

As the level of expertise assigned to the skill tags 14 is endorsed by suitably qualified subjects 12, the social-network skill system 10 may be viewed as creating trust in the skills associated with different people in the social-network skill system 10. It will be appreciated that the social-network skill system 10 may first need to be “seeded” in order that one or more subjects are initially endorsed with a certain level (typically the highest level) of expertise for each of the skill tags 14. The social-network skill system 10 may be seeded based on human resource database information, or parsing resume information and professional qualification registers, by way of example only.

The social-network skill system 10 includes a processor 16; a memory 18; and a skills database 20. The memory 18 is operative to store data used by the processor 16.

The processor 16 is operative to maintain the skills database 20. The skills database 20 includes: a plurality of different skill tags 14, each of the skill tags having an associated description 22; and a plurality of different subjects 12, each of the subjects being associated with a person.

The processor 16 is operative to receive endorsements from the subjects 12 endorsing skill tags 14 of other subjects 12. FIG. 1 shows the processor 16 receiving an endorsement 24 for one of the subjects 12-A (Richard in the example of FIG. 1) from another one of the subjects 12-B (Sam in the example of FIG. 1) endorsing a skill tag 14-A of the subject 12-A (Richard).

The processor 16 is operative to create a link 26 linking the subject 12-A (Richard) with the skill tag 14-A in the skills database 20. The link 26 may be created by the subject 12-A (Richard) adding the skill tag 14-A himself (self-tagging) (an expertise level may be added later when an appropriate endorsement is received), or initiated by receiving the endorsement 24 or from receiving a previous endorsement.

Based on receiving the endorsement 24, the processor 16 is operative to assign, in the skills database 20, an expertise level 28 to the skill tag 14-A of the subject 12-A using a link 30. The expertise level 28 that can be assigned to the skill tag 14-A of the subject 12-A is dependent at least on the skill tag(s) 14 of the subject 12-B (Sam) and the expertise level(s) assigned to the skill tag(s) 14 of the subject 12-B (Sam). If the subject 12-A already has an expertise level 28 associated with the skill tag 14-A, the endorsement 24 may cause the expertise level 28 of the skill tag 14-A to be updated.

The expertise level 28 may expressed as a score or weighting or ranking (for example, but not limited to, novice, intermediate, expert, guru etc.). The expertise level 28 applied to the skill tag 14-A may depend on the number of endorsements and/or the expertise level of the endorser. For example, receiving an endorsement from an expert may carry a score of 5 whereas receiving an endorsement from a guru may carry a score of 10. Receiving an endorsement from two experts may carry a score of 10 (i.e.: twice the value of one expert) or 12 (incremented by an additional score of 2 to account for the fact that two experts have endorsed the same skill of the same subject), by way of example only.

The value of the score to be applied to the expertise level 28 may depend on a level of expertise assigned by the endorser to the skill tag 14-A of the subject 12-A in the endorsement 24. It will be appreciated that the level of expertise assigned by the endorser is valuable if the endorser has the same level of expertise, or higher level of expertise than the level of expertise assigned by the endorser. Thus, generally, the expertise level 28 cannot be assigned to the skill tag 14-A of the subject 12-A unless the skill tag 14-A of the subject 12-A is endorsed by the subject 12-13 having the skill tag 14-A with an expertise level higher than, or equal to, the expertise level 28 or having the skill tag 14 defined in the skills database 20 to include the skill tag 14-A and having an expertise level higher than, or equal to, the expertise level 28. The number of endorsements required to define a skill ranking may be configurable. For example, a subject may need to receive 4 endorsements from experts to be assigned an expert level of expertise, and 10 endorsements from gurus to be assigned a guru level of expertise. The semantics of the expertise level (for example, but not limited to, novice, intermediate, expert, guru etc.) may be implemented using a concept relationship vocabulary such as Freebase (Freebase is a large collaborative knowledge base consisting of metadata composed mainly by its community members. It is an online collection of structured data harvested from many sources, including individual, user-submitted wiki contributions. Freebase aims to create a global resource which allows people (and machines) to access common information more effectively. It was developed by the American software company Metaweb and has been running publicly since March 2007) or a domain specific vocabulary, if required.

Therefore, the processor 16 is operative to assign, in the skills database 20, the expertise level 28 to the skill tag 14-A of the subject 12-A at least dependent upon the skill tag 14-B of the subject 12-B being the skill tag 14-A or the skill tag 14-B of the subject 12-B being defined in the skills database 20 to include the skill tag 14-A (in other words the definition of the skill tag 14-B includes the skills of the skill tag 14-A).

Optionally, the processor 16 is operative to assign, in the skills database 20, the expertise level 28 to the skill tag 14-A of the subject 12-A such that the expertise level of the skill tag 14 (the skill tag 14-A or a skill tag 14 including the skins of the skill tag 14-A) of the subject 12-B is of higher expertise than, or is equal to, the expertise level 28 to be assigned to the skill tag 14-A of the subject 12-A, in other words, the processor 16 is optionally operative to assign the expertise level 28 to the skill tag 14-A of the subject 12-A being endorsed to be no greater than the expertise level of the skill tag 14 of the endorser.

As described above, the social-network skill system 10 may be partially implemented on a server or in a cloud environment.

Alternatively, or additionally, the social-network skill system 10 may be implemented in a Social-Semantic Web information space based environment as will be described in more detail below. The Semantic Web augments the World Wide Web representing the Web's information in a machine-readable fashion and enables targeted searching, data browsing and automated agents.

One tool used in the Social-Semantic web information space based environment is RDF (Resource Description Framework). The RDF 1.1 specification consists of a suite of W3C Recommendations and Working Group Notes, published in 2014. RDF provides a labeled, directed graph of relations between resources and literal values and a schema-less data model that features unambiguous identifiers and names relations between pairs and resources. RDF graphs are a collection of triples made up of a subject, a predicate and an object, for example, for the relationship “Sam has C++ skill tag”, “Sam” is the subject, “has” is the predicate, and “C++” is the object. Resources (subjects and Objects) and relationships (predicates) may be names with Uniform Resource Identifiers (URIs). Predicates may also be used to create the link 30 between the skill tags 14 and the expertise level 28. The graph structure of RDF greatly simplifies merging data with shared identifiers. Using URI's for naming removes ambiguity. For example, a tag entitled “Java” could relate to someone with knowledge of the programming language JAVA or knowledge of the Island of Java. Therefore, each of the skill tags 14 has an associated description 22 and a unique URI so that each skill tag 14 provides a way to tag a particular skill unambiguously.

Relationships defined by the predicates may be defined using an ontology, and in particular, by extending an existing ontology such as e.g.: FOAF (friend of a friend). Ontologies are considered one of the pillars of the Semantic Web, although they do not have a universally accepted definition. A (Semantic Web) vocabulary can be considered as a special form of (usually light-weight) ontology, or sometimes also merely as a collection of URIs with an (usually informally) described meaning.

An enterprise social software user interface (UI) may be implemented to allow users to browse or search expertise or content in the skills database 20. The UI software may enable users to retrieve the meaning of a skill tag 14 by hovering over the skill tag 14. This “hovering” feature may be used when adding tags 14 (self tagging), adding tags 14 when endorsing skill tags 14 or searching to find a person/people with a particular skill tag 14.

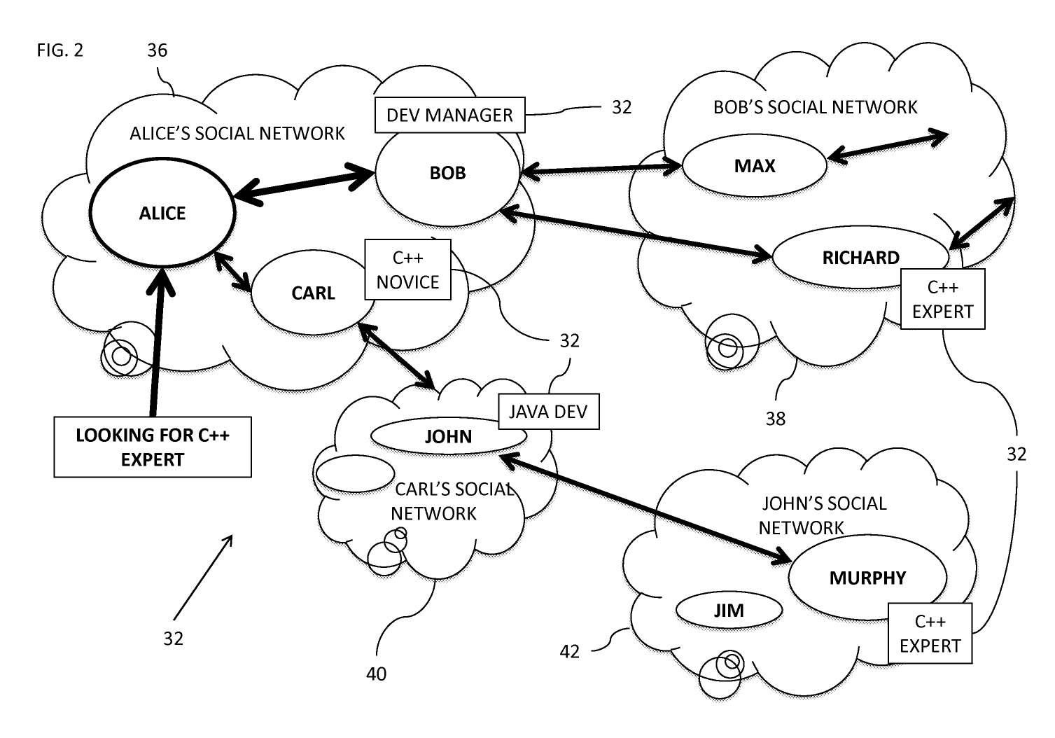

Reference is now made to FIG. 2, which is a partly pictorial, partly block diagram view of social networks 32 with endorsed skill tag expertise levels 34.

FIG. 2 shows four social networks 32, Alice's social network 36, Bob's social network 38, Carl's social network 40 and John's social network 42.

Subjects 12 who are in the same social network are separated by asocial distance of 1. Subjects 12 who are connected to a subject 12 via another subject are separated by a social distance of 2, and so on, In the example of FIG. 2, Bob and Carl are a social distance of 1 from Alice and John is a social distance of 2 from Alice.

FIG. 2 shows that Alice is looking for a C++ expert. Alice's social network 36 includes Bob and Carl. Carl is a C++ novice. Carl's social network 40 includes John who is a Java developer. Bob's social network 38 includes Max and Richard. Richard is a C++ expert, John's social network 42 includes Jim and Murphy. Murphy is also a C++ expert.

Although Carl is in Alice's social network 36, Carl is a C++ novice and although Murphy and Richard are not in Alice's social network 36, they are C++ experts.

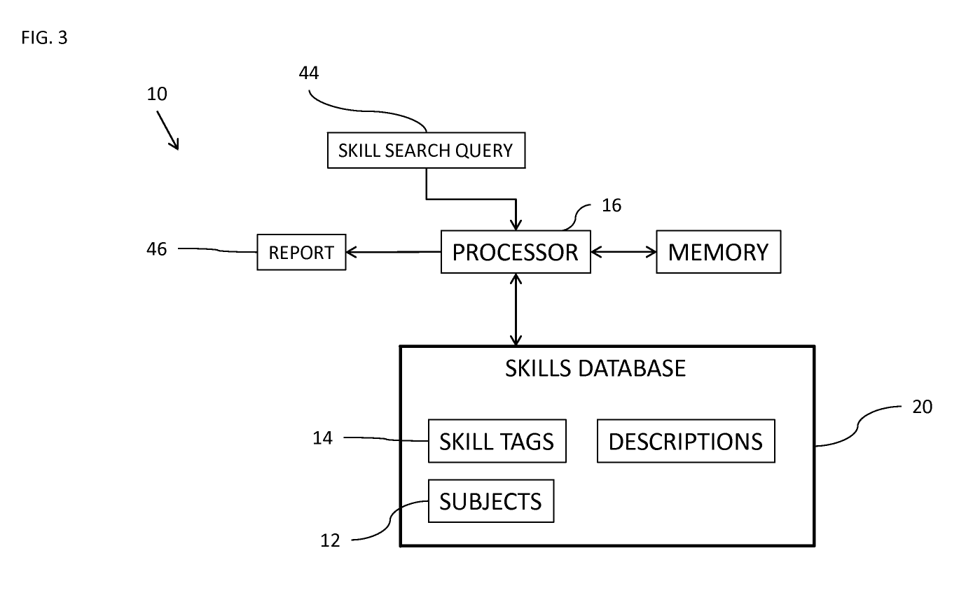

A search for a particular skill tag 14 (FIG. 1) may take into account the expertise level 28 and/or the social distance from the person searching for the skill tag 14. The search results may also include a score which is a function of the expertise level 28 and/or the social distance from the person searching for the skill tag 14 as will be described in more detail with reference to FIGS. 3-6.

Reference is now made to FIG. 3, which is a block diagram view of the social-network skill system 10 processing a skill search query 44 to find the subject(s) 12 having a particular skill tag 14.

The processor 16 is operative to receive the skill search query 44 from a user to find the subject(s) 12 having a particular skill tag 14.

The processor 16 is operative to search the skills database 20 for results of the skill search query 44 and prepare a report 46.

Performing a search and preparing the report 46 within the context of a Social-Semantic Web information space based environment is now described with reference to FIG. 2.

The search may be performed using the friend of a friend social graph concept in order to determine the expertise most connected to Alice. The search starts by first traversing the social graph of Alice in Alice's social network 36 to find trusted friends with the required skill (C++). Carl is found to have C++ at novice level. The trust is said to be transitive in that the search would then go to friends of friends and so on until a suitable expert is found. For example the search would first go to Carl's social network 40 and Bob's social network 38 (finding Richard who is a C++ expert) before going to John's social network 42 (finding Murphy who is another C++ expert). The search may continue to more remote social networks until a certain number of experts are found or until a certain number of neighboring social networks have been traversed according to user defined search settings. The results can then be presented in the report 46 (FIG. 3) listing the subjects 12 found in the search. A graph limit may be employed after which the trust breaks down.

The social-network skill system 10 may combine social distance with skill weighting/score/rank to provide a measure of transitive trust. Transitivity is a highly desired property of a trust metric, in situations where A trusts B and B trusts C, transitivity concerns the extent to which A trusts C. Without transitivity, trust metrics are unlikely to be used to reason about trust in more complex relationships. For example a direct (one degree separation) friend with a high skill rating may be given a high trust index compared to a friend of a friend (two degrees of separation) even with the same skill rating.

The search results may be saved for future searches and updating the user's social graph with the new results.

An example report 46 (FIG. 3) is shown below.

“Murphy [skill-level: Expert, Recommended by John (not in your network) with social distance of 2, 12 Endorsements]

Richard [skill-level: Expert, Recommended by Carl with Social Distance 1, 4 Endorsements]”

Alice can then chose either Murphy or Richard and implicitly/explicitly provide feedback to update the social graph with trust relationships, Alice may eventually add John, Murphy and Richard to her social trust graph with semantic annotations representing the context of the addition.

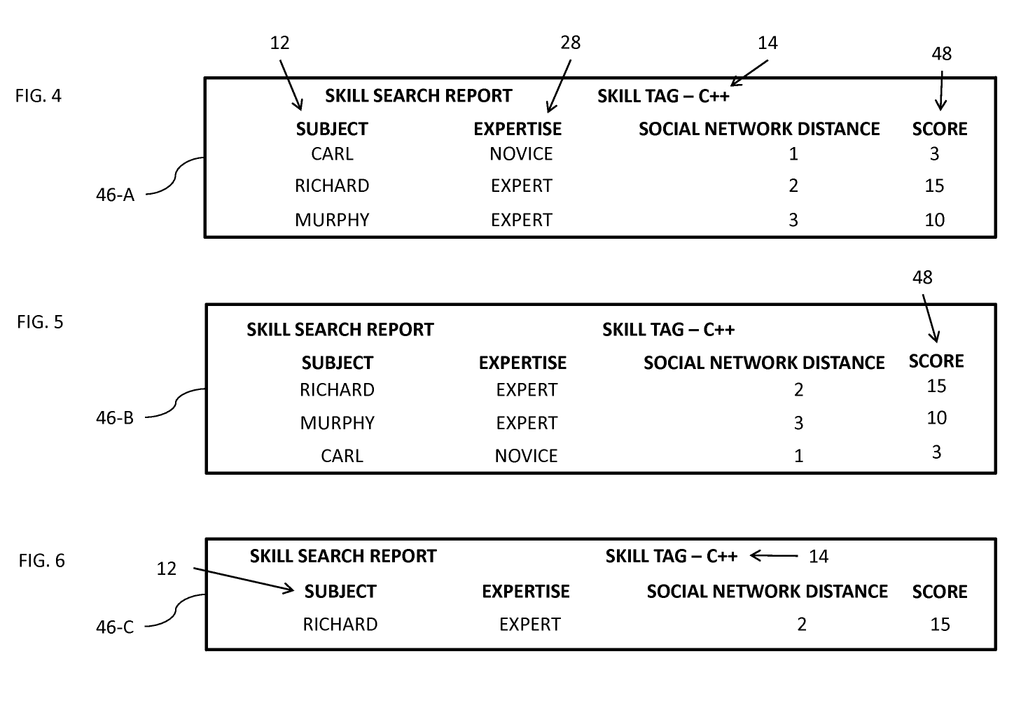

Other examples of the report 46 are shown in FIGS. 4-6.

Reference is now made to FIG. 4, which is a view of a skill search report 46-A produced by the system 10 of FIG. 1 and ordered by social network distance and then by expertise.

The processor 16 (FIG. 3) is operative to receive the skill search query 44 (FIG. 3) to find the subjects 12 having a particular skill tag 14. The processor 16 is operative to query the skills database 20 (FIG. 3). Based on the query, the processor 16 is operative to prepare the report 46-A including the subjects 12 having the particular skill tag 14. The report includes an expertise level 28 associated with each of the subjects 12 having the particular skill tag 14. The report may be sorted by the social distance and then by the expertise level.

The report may also include a score 48 which is a function of social distance and expertise level. By way of example, the score 48 may be determined by assigning each skill rank a value, for example, novice=3, expert=30 etc. and then dividing the value by the social distance. So for example, for Carl who is a novice and has a social network distance of 1, the score would be calculated as 3/1=3. For Richard who is an expert and has a social distance of 2, the score would be calculated as 30/2=15 and so on.

It will be appreciated that the report 46-A may be prepared without listing the social network distance and/or sorted by expertise level alone.

Reference is now made to FIG. 5, which is a view of a skill search report 46-B produced by the system 10 of FIG. 1 and ordered by expertise (and/or the score 48) and then social network distance.

It will be appreciated that the report 46-B may be prepared without listing the social network distance and/or being sorted by the social network distance.

Reference is now made to FIG. 6, which is a view of a skill search report 46-C produced by the system 10 of FIG. 1 listing only the highest scoring result.

The processor 16 (FIG. 3) is operative to receive a skill search query to find the subjects 12 having a particular skill tag 14 with a highest expertise level and optionally also with the closest social distance to the subject requesting the search. The search may be limited to a certain number of nearest neighbor social networks. The processor 16 is operative to query the skills database 20 and based on the query the processor 16 is operative to prepare the report 46-C including the subject 12 having the particular skill tag 14 with the highest expertise level and optionally with the closest social distance to the subject requesting the search.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof.

What is claimed is:

1. A system comprising a processor; and a memory to store data used by the processor, wherein the processor is operative to:
maintain a skills database including: a plurality of different skill tags, each of the skill tags having an associated description; and a plurality of different subjects, each of the subjects being associated with a person;
receive an endorsement for a first one of the subjects from a second one of the subjects endorsing a first one of the skill tags of the first subject;
create a link linking the first subject with the first skill tag in the skills database; and
based on receiving the endorsement, assign, in the skills database, a first expertise level to the first skill tag of the first subject, the first expertise level being dependent at least on one of the skill tags of the second subject and on a second expertise level assigned to the one skill tag of the second subject.

2. The system according to claim 1, wherein the processor is operative to assign, in the skills database, the first expertise level to the first skill tag of the first subject dependent at least upon the one skill tag of the second subject being the first skill tag.

3. The system according to claim 2, wherein the processor is operative to assign, in the skills database, the first expertise level to the first skill tag of the first subject such that the second expertise level of the one skill tag of the second subject is of higher expertise than, or is equal to, the first expertise level to be assigned to the first skill tag of the first subject.

4. The system according to claim 1, wherein the processor is operative to assign, in the skills database, the first expertise level to the first skill tag of the first subject at least dependent upon the one skill tag of the second subject being defined in the skills database to include the first skill tag.

5. The system according to claim 4, wherein the processor is operative to assign, in the skills database, the first expertise level to the first skill tag of the first subject such that the second expertise level of the one skill tag of the second subject is of higher expertise than, or is equal to, the first expertise level to be assigned to the first skill tag of the first subject.

6. The system according to claim 1, wherein the first expertise level cannot be assigned to the first skill tag of the first subject unless the first skill tag of the first subject is endorsed by the second subject having the first skill tag with an expertise level higher than, or equal to, the first expertise level or having the one skill tag defined in the skills database to include the first skill tag and having an expertise level higher than, or equal to, the first expertise level.

7. The system according to claim 1, wherein the processor is operative to:
receive a skill search query from a third one of the subjects to find the subjects having the first skill tag;
query the skills database; and
based on the query, prepare a report including at least some of the subjects having the first skill tag, the report including an expertise level associated with each of the at least some subjects having the first skill tag and a social distance from the third subject.

8. The system according to claim 7, wherein the report is sorted by the social distance and the expertise level.

9. The system according to claim 1, wherein the processor is operative to:
receive a skill search query to find one of the subjects having first skill tag with a highest expertise level;
query the skills database; and
based on the query, prepare a report including the one subject having the first skill tag with the highest expertise level.

10. The system according to claim 1, wherein the processor is operative to:
receive a skill search query from a third one of the subjects to find one of the subjects having the first skill tag with a highest expertise level and with the closest social distance to the third subject;
query the skills database; and
based on the query, prepare a report including the one subject having the first skill tag, with the highest expertise level and the closest social distance to the third subject.

11. A method comprising:
maintaining a skills database including: a plurality of different skill tags, each of the skill tags having an associated description; and a plurality of different subjects, each of the subjects being associated with a person;
receiving an endorsement for a first one of the subjects from a second one of the subjects endorsing a first one of the skill tags of the first subject;
creating a link linking the first subject with the first skill tag in the skills database; and
based on receiving the endorsement, assigning, in the skills database, a first expertise level to the first skill tag of the first subject, the first expertise level being dependent at least on one of the skill tags of the second subject and on a second expertise level assigned to the one skill tag of the second subject.

12. The method according to claim 11, wherein the assigning the first expertise level to the first skill tag of the first subject is dependent at least upon the one skill tag of the second subject being the first skill tag.

13. The method according to claim 12, wherein the assigning the first expertise level to the first skill tag of the first subject is performed such that the second expertise level of the one skill tag of the second subject is of higher expertise than, or is equal to, the first expertise level to be assigned to the first skill tag of the first subject.

14. The method according to claim 11, wherein the assigning the first expertise level to the first skill tag of the first subject is at least dependent upon the one skill tag of the second subject being defined in the skills database to include the first skill tag.

15. The method according to claim 14, wherein the assigning the first expertise level to the first skill tag of the first subject is performed such that the second expertise level of the one skill tag of the second subject is of higher expertise than, or is equal to, the first expertise level to be assigned to the first skill tag of the first subject.

16. The method according to claim 11, wherein the first expertise level cannot be assigned to the first skill tag of the first subject unless the first skill tag of the first subject is endorsed by the second subject having the first skill tag with an expertise level higher than, or equal to, the first expertise level or having the one skill tag defined in the skills database to include the first skill tag and having an expertise level higher than, or equal to, the first expertise level.

17. The method according to claim 11, further comprising:
receiving a skill search query from a third one of the subject to find the subjects having the first skill tag;
querying the skills database; and
based on the querying, preparing a report including at least some of the subjects having the first skill tag, the report including an expertise level associated with each of the at least some subjects having the first skill tag and a social distance from the third subject.

18. The method according to claim 17, wherein the report is sorted by the social distance and the expertise level.

19. The method according to claim 11, further comprising:
receiving a skill search query to find one of the subjects having the first skill tag with a highest expertise level;
querying the skills database; and
based on the querying, preparing a report including the one subject having the first skill tag with the highest expertise level.

20. The method according to claim 11, further comprising:
receiving a skill search query from a third one of the subject to find one of the subjects having the first skill tag with a highest expertise level with the closest social distance to the third subject;
querying the skills database for results of the skill search query; and
based on the querying, preparing a report including the one subject having the first skill tag, with the highest expertise level and the closest social distance to the third subject.
